(19) United States
(12) Patent Application Publication
(10) Pub. No.: US 2005/0111316 A1
(43) Pub. Date: May 26, 2005

(54) Optical disc apparatus, access method, program and semiconductor integrated circuit

(76) Inventors: Masahito Nakao, Osaka (JP); Kiyokazu Hashimoto, Osaka (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/965,448

(22) Filed: Oct. 14, 2004

(30) Foreign Application Priority Data
Oct. 15, 2003 (JP) 2003-355437

(51) Int. Cl. G11B 5/09

(52) U.S. Cl. 369/47.27; 369/59.23

(57) ABSTRACT

An optical disc apparatus is provided for accessing an optical disc having at least one track, in which at least one prepit is provided in the at least one track. The apparatus comprises a light irradiation section for irradiating the at least one track with light, a first signal generating section for detecting light reflected from the at least one track, and based on the reflected light, generating a first signal including a prepit signal indicating the at least one prepit, a second signal generating section for removing a signal component impeding detection of the prepit signal from the first signal to generate a second signal, and a prepit detecting section for detecting the at least one prepit based on at least one of the first signal and the second signal.

This nonprovisional application claims priority under 35 U.S.C. §119(a) on Patent Application No. 2003-35437 filed in Japan on Oct. 15, 2003, the entire contents of which are hereby incorporated by reference.

### BACKGROUND OF THE INVENTION

1. Field of the Invention

The present invention relates to an optical disc apparatus and an access method for accessing an optical disc having at least one track, a program for causing a computer to execute an access process to an optical disc, and a semiconductor integrated circuit for executing an access process to an optical disc.

2. Description of the Related Art

Conventionally, optical disc apparatuses comprise a detecting means for detecting light reflected from an area on one side of the center of a track, which is closer to the outer circumference of an optical disc (hereinafter referred to as an outer circumferential area), and a detecting means for detecting light reflected from an area on the other side of the center of a track, which is closer to the inner circumference of an optical disc (hereinafter referred to as an inner circumferential area). In order to detect a prepit formed on an optical disc, the conventional optical disc apparatus adjusts each of the amplitudes of two detection signals detected by the two detecting means to reduce a signal component which impedes the detection of a prepit. As a result, the detection accuracy of a prepit can be improved (see, for example, Japanese Laid-Open Publication No. 2002-216363 (pages 5-6, FIGS. 3 and 7) and Japanese Laid-Open Publication No. 2003-30831 (pages 6-10, FIGS. 5 and 11)).

However, in the conventional optical disc apparatus, the amplitudes of the two detection signals may not be individually adjusted.

For example, if the amplitudes of the two detection signals vary due to the shape of a reproduction beam spot of an optical pickup (particularly, the shape of a beam spot in a radial direction) or the warpage (tilt) of an optical disc, the amplitudes of the two detection signals cannot be individually adjusted. Therefore, a signal component which impedes the detection of a prepit is increased, and the detection accuracy of a prepit is significantly deteriorated, especially when data is reproduced with high speed.

### SUMMARY OF THE INVENTION

According to an aspect of the present invention, an optical disc apparatus is provided for accessing an optical disc having at least one track, wherein at least one prepit is provided in the at least one track. The apparatus comprises a light irradiation section for irradiating the at least one track with light, a first signal generating section for detecting light reflected from the at least one track, and based on the reflected light, generating a first signal including a prepit signal indicating the at least one prepit, a second signal generating section for removing a signal component impeding detection of the prepit signal from the first signal to generate a second signal, and a prepit detecting section for detecting the at least one prepit based on at least one of the first signal and the second signal. Thereby, the above-described object can be achieved.

In one embodiment of this invention, the at least one track may comprise an outer circumferential area on an outer circumferential side of a center of the track and an inner circumferential area on an inner circumferential side of the center of the track. The reflected light may comprise a first reflected light reflected from the outer circumferential area and a second reflected light reflected from the inner circumferential area. The first signal generating section may comprise a first light detection signal generating section for detecting the first reflected light, and based on the detected first reflected light, generating a first light detection signal, a second light detection signal generating section for detecting the second reflected light, and based on the detected second reflected light, generating a second light detection signal, and a difference signal generating section for generating the first signal based on a difference between the first light detection signal and the second light detection signal.

In one embodiment of this invention, the difference signal generating section may comprise an adjustment section for adjusting at least one of an amplitude of the first light detection signal and an amplitude of the second light detection signal so that a ratio of the amplitude of the first light detection signal and the amplitude of the second light detection signal is 1:1.

In one embodiment of this invention, the optical disc apparatus may further comprise a feedback section for feedbacking a predetermined signal to the first signal to cause the second signal to have a predetermined potential.

In one embodiment of this invention, the feedback section may feedback the predetermined signal to the first signal so that a value of the predetermined potential is an average value of the second signal.

In one embodiment of this invention, the optical disc apparatus may further comprise a section for causing an output value of the feedback section to be constant.

In one embodiment of this invention, the second signal generating section may comprise a synchronization signal generating section for generating a synchronization signal which is in synchronization with a timing of occurrence of the signal component, and a switching section for switching, based on the synchronization signal, between an output of the first signal and an output of a first reference signal indicating a predetermined reference value.

In one embodiment of this invention, the at least one track may comprise an outer circumferential area on an outer circumferential side of a center of the track and an inner circumferential area on an inner circumferential side of the center of the track. The reflected light may comprise a first reflected light reflected from the outer circumferential area and a second reflected light reflected from the inner circumferential area. The first signal generating section may comprise a first light detection signal generating section for detecting the first reflected light, and based on the detected first reflected light, generating a first light detection signal, and a second light detection signal generating section for detecting the second reflected light, and based on the detected second reflected light, generating a second light detection signal. The synchronization signal generating section may comprise a sum signal generating section for generating a sum signal indicating a sum of the first light detection signal and the second light detection signal, a binary signal generating section for generating a binary signal based on the sum signal and a second reference signal indicating a predetermined reference value, and a mono-multi section for changing the binary signal to a mono-multi signal to generate the synchronization signal.

In one embodiment of this invention, the at least one track may comprise an outer circumferential area on an outer circumferential side of a center of the track and an inner circumferential area on an inner circumferential side of the center of the track. The reflected light may comprise a first reflected light reflected from the outer circumferential area and a second reflected light reflected from the inner circumferential area. The first signal generating section may comprise a first light detection signal generating section for detecting the first reflected light, and based on the detected first reflected light, generating a first light detection signal. A second light detection signal generating section for detecting the second reflected light, and based on the detected second reflected light, generating a second light detection signal. The synchronization signal generating section may comprise a sum signal generating section for generating a sum signal indicating a sum of the first light detection signal and the second light detection signal, a filtering section for filtering the sum signal, and a binary signal generating section for generating a binary signal based on the filtered sum signal and a third reference signal indicating a predetermined reference value.

In one embodiment of this invention, the first reference signal may indicate an average value of the second signal.

In one embodiment of this invention, the synchronization signal generating section may further comprise a determination section for determining whether or not the optical disc apparatus is accessing an area of the optical disc in which data is recorded. When the determination section determines that the optical disc apparatus is not accessing the area, the switching section may maintain the output of the first signal.

In one embodiment of this invention, the signal component may be generated by modulation of the light. The signal component may be superposed on the first signal.

In one embodiment of this invention, the at least one track may comprise at least one formation area, in which at least one recording mark is provided. The signal component may be generated due to a difference between a reflectance of light reflected from the at least one formation area and a reflectance of light reflected from an area other than the at least one formation area. The signal component may be superposed on the first signal.

In one embodiment of this invention, the prepit detecting section may detect the at least one prepit with reference to a sample hold signal generated based on the first signal.

In one embodiment of this invention, the prepit detecting section may detect the at least one prepit with reference to a sample hold signal generated based on the second signal.

In one embodiment of this invention, the prepit detecting section may detect the at least one prepit with reference to a sample hold signal generated based on an average value of the second signal.

According to another aspect of the present invention, an access method is provided for accessing an optical disc having at least one track, wherein at least one prepit is provided in the at least one track. The method comprises irradiating the at least one track with light, detecting light reflected from the at least one track, and based on the reflected light, generating a first signal including a prepit signal indicating the at least one prepit, removing a signal component impeding detection of the prepit signal from the first signal to generate a second signal, and detecting the at least one prepit based on at least one of the first signal and the second signal. Thereby, the above-described object is achieved.

According to another aspect of the present invention, a program is provided for causing a computer to execute an access process for accessing an optical disc having at least one track, wherein at least one prepit is provided in the at least one track. The access process comprises irradiating the at least one track with light, detecting light reflected from the at least one track, and based on the reflected light, generating a first signal including a prepit signal indicating the at least one prepit, removing a signal component impeding detection of the prepit signal from the first signal to generate a second signal, and detecting the at least one prepit based on at least one of the first signal and the second signal. Thereby, the above-described object is achieved.

According to another aspect of the present invention, a semiconductor integrated circuit is provided for controlling access to an optical disc having at least one track, wherein at least one prepit is provided in the at least one track. The circuit may comprise a first signal generating section for detecting light reflected from the at least one track, and based on the reflected light, generating a first signal including a prepit signal indicating the at least one prepit, a second signal generating section for removing a signal component impeding detection of the prepit signal from the first signal to generate a second signal, and a prepit detecting section for detecting the at least one prepit based on at least one of the first signal and the second signal. Thereby, the above-described object is achieved.

According to the optical disc apparatus, the access method, the program for causing a computer to execute an access process to an optical disc, and the semiconductor integrated circuit of the present invention, a prepit formed on an optical disc can be detected based on at least one of a first signal generated based on light reflected from the optical disc and a second signal generated by removing a signal component, which impedes detection of a prepit signal indicating at least one prepit, from the first signal.

Therefore, no matter whether or not a signal component impeding detection of a prepit signal is contained in the first signal, a prepit formed on an optical disc can be detected, resulting in an improvement in the accuracy of detecting a prepit.

According to the optical disc apparatus of the present invention, a signal on which a signal component impeding detection of a prepit signal is replaced with a signal having a desired level, a signal component impeding detection of a prepit signal can be removed. As a result, the detection accuracy of a prepit is improved.

According to the optical disc apparatus of the present invention, it is possible to solve the problem that the detection accuracy of a prepit is deteriorated by a variation in the amplitudes of two detection signals due to the warpage (tilt) or the like of an optical disc.

Thus, the invention described herein makes possible the advantages of providing an optical disc apparatus and an access method capable of detecting a prepit more accurately, a program for causing a computer to execute an access process to an optical disc, and a semiconductor integrated circuit for executing an access process to an optical disc.

These and other advantages of the present invention will become apparent to those skilled in the art upon reading and understanding the following detailed description with reference to the accompanying figures.

### BRIEF DESCRIPTION OF THE DRAWINGS

FIG. 1 shows a configuration of an optical disc apparatus according to Embodiment 1 of the present invention.

FIG. 2 shows a detail of an optical disc.

FIGS. 3A to 3C are diagrams for explaining a function of a light detecting section.

FIG. 4 shows an exemplary configuration of a prepit signal detecting block.

FIG. 5 shows a first difference signal generated based on light reflected from an unrecorded track.

FIGS. 6A to 6D are diagrams for explaining a detail of an exemplary switching pulse generating circuit.

FIGS. 7A to 7D are diagrams for explaining a detail of another exemplary switching pulse generating circuit.

FIGS. 8A and 8B are diagrams for explaining a detail of a recorded area detecting circuit and a switching circuit.

FIGS. 9A and 9B are diagrams for explaining a detail of a slice signal generating circuit.

FIGS. 10A and 10B are diagram showing a waveform of a signal generated by a plurality of components included in the above-described prepit detecting block when data is recorded onto the above-described optical disc.

FIG. 11 is a diagram showing a waveform of a signal generated by a plurality of components included in the above-described prepit detecting block when light reflected from a track, in which no data is recorded (reproduction of an unrecorded track), is detected.

FIGS. 12A and 12B are diagrams showing a waveform of a signal generated by a plurality of components included in the above-described prepit detecting block when data is reproduced from the above-described optical disc.

FIG. 13 shows another exemplary configuration of the above-described prepit signal detecting block.

### DESCRIPTION OF THE PREFERRED EMBODIMENTS

Hereinafter, the present invention will be described by way of illustrative examples with reference to the accompanying drawings.

### Embodiment 1

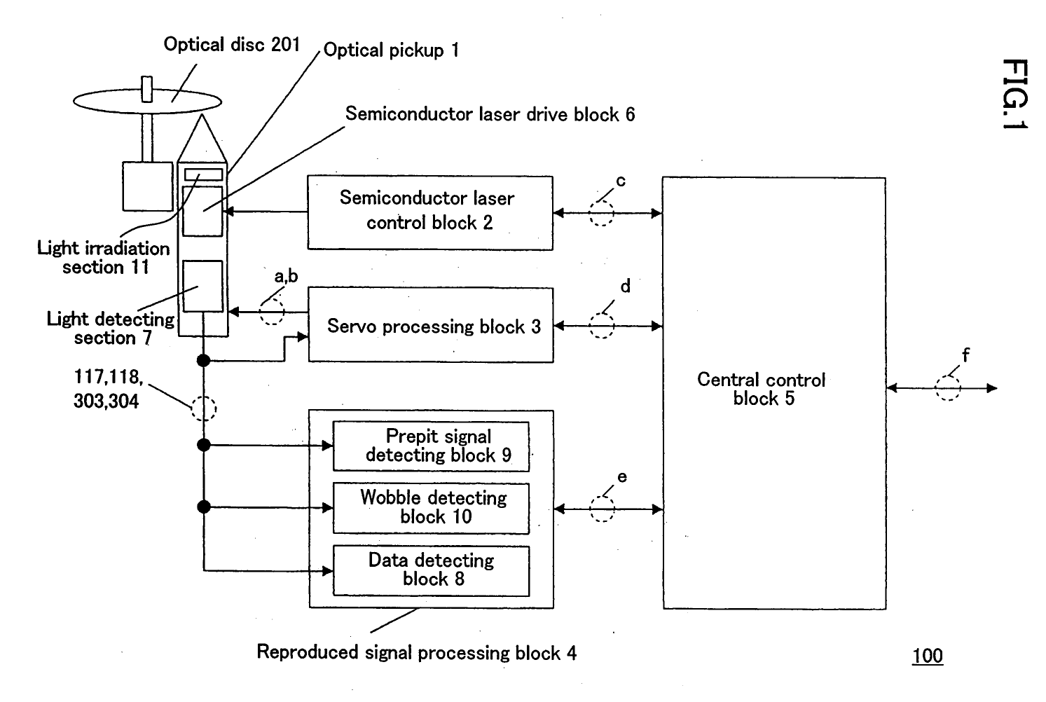

FIG. 1 shows a configuration of an optical disc apparatus 100 according to Embodiment 1 of the present invention.

The optical disc apparatus 100 is designed so that an optical disc 201 can be inserted thereinto. The optical disc apparatus 100 accesses the inserted optical disc 201. For example, the optical disc apparatus 100 accesses the optical disc 201 in order to record data onto the optical disc 201. For example, the optical disc apparatus 100 accesses the optical disc 201 in order to reproduce data from the optical disc 201.

The optical disc apparatus 100 comprises an optical pickup 1, a semiconductor laser control block 2 and a servo processing block 3 for controlling the optical pickup 1, a reproduced signal processing block 4 for processing a reproduced signal output by the optical pickup 1, and a central control block 5 for controlling a plurality of components included in the optical disc apparatus 100.

The central control block 5 controls a plurality of components in accordance with a control signal f output by an external computer (not shown). The central control block 5 generates a control signal a, a control signal d, and a control signal e in order to control a plurality of components. The central control block 5 outputs the control signal a to the semiconductor laser control block 2, the control signal d to the servo processing block 3, and the control signal e to the reproduced signal processing block 4.

The semiconductor laser control block 2 controls the optical pickup 1 based on the control signal a. The servo processing block 3 controls the optical pickup 1 based on the control signal d. The reproduced signal processing block 4 processes a reproduced signal based on the control signal e.

The optical pickup 1 is designed to record data onto the optical disc 201 or reproduce data from the optical disc 201. The optical pickup 1 comprises a light irradiation section 11 for irradiating at least one track formed on the optical disc 201 with light, a semiconductor laser drive block 6, and a light detecting section 7.

The reproduced signal processing block 4 comprises a data detecting block 8, a prepit signal detecting block 9, 13- and a wobble detecting block 10.

Details of the optical pickup 1 and the reproduced signal processing block 4 will be described elsewhere herein.

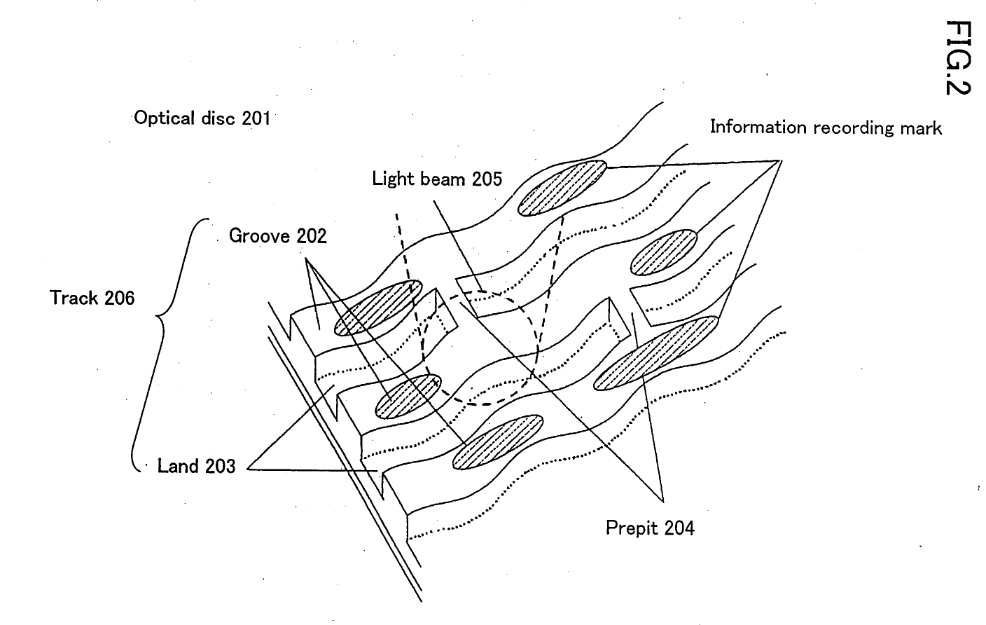

FIG. 2 shows a detail of the optical disc 201.

The optical disc 201 is, for example, a DVD-R. At least one track 206 is formed on the optical disc 201. In the track 206, at least one prepit 204 is formed. The track 206 is a linear information recording area, typically containing a groove 202 and a land 203. The groove 202 is in the shape of a concentric circle or a spiral, wobbling with a predetermined frequency. The prepit 204 is formed on at least one of two side edge portions of the groove 202.

Hereinafter, an operation of the optical disc apparatus 100, which detects wobble of the groove 202 and the prepit 204, will be described with reference to FIGS. 1 and 2.

The semiconductor laser control block 2 sets the reproduction power. The semiconductor laser drive block 6 determines a drive current for the light irradiation section 11 (e.g., a semiconductor laser apparatus) based on the set reproduction power. The light irradiation section 11 irradiates the optical disc 201 with a light beam 205 having a predetermined laser power. The light beam 205 is reflected from the optical disc 201. The light detecting section 7 detects the reflected light.

The track 206 comprises an area on one side of a center of the track 206, which is closer to the outer circumference of the optical disc 201 (hereinafter referred to as an outer circumferential area) and an area on the other side of the center of the track 206, which is closer to the inner circumference of the optical disc 201 (hereinafter referred to as an inner circumferential area). The reflected light comprises a first reflected light reflected from the outer circumferential area and a second reflected light reflected from the inner circumferential area.

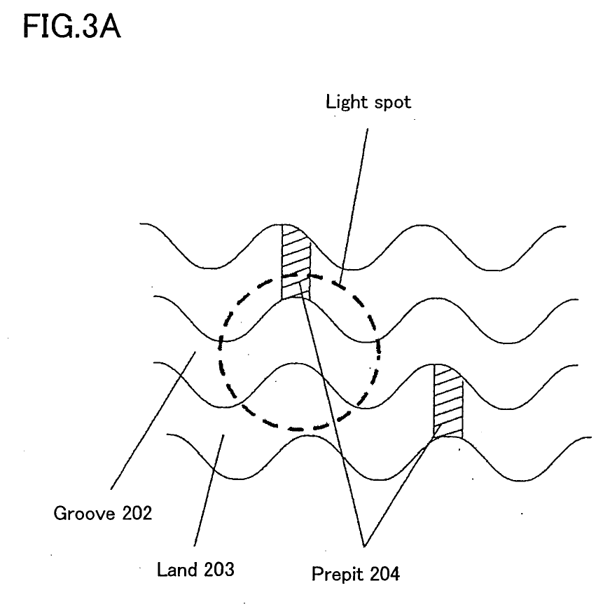

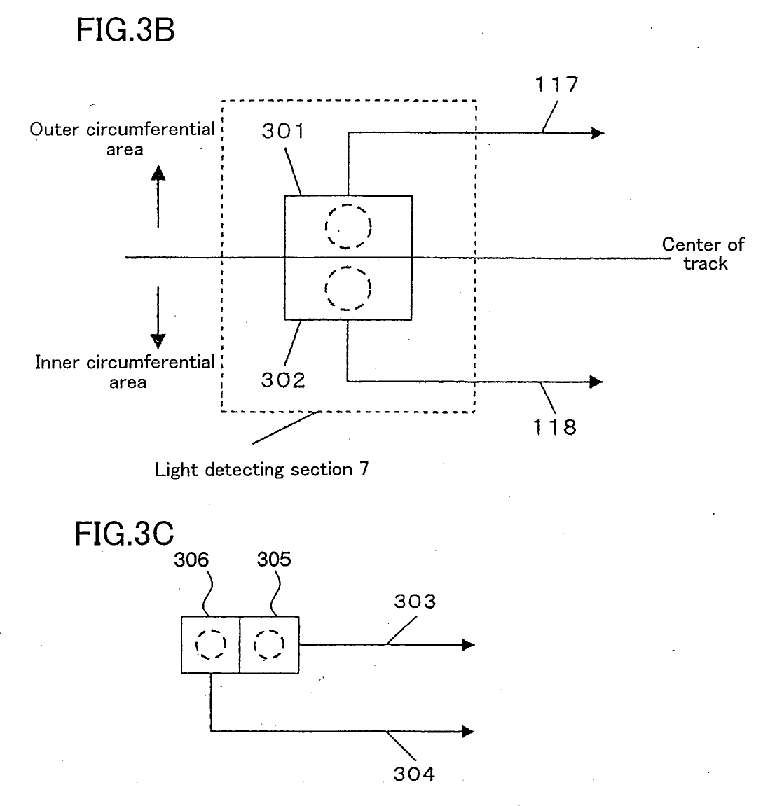

FIGS. 3A to 3C are diagrams for explaining a function of the light detecting section 7. FIG. 3A shows a spot of light emitted onto the optical disc 201. FIGS. 3B and 3C show a configuration of the light detecting section 7.

The light detecting section 7 comprises a first light detecting section 301 and a second light detecting section 302 (see FIG. 3B). The first light detecting section 301 and the second light detecting section 302 are arranged side by side in a direction (a radial direction of the disk) perpendicular to a longitudinal direction (track direction) of the groove 202.

The first light detecting section 301 detects the first reflected light, and based on the detected first reflected light, generates a first light detection signal 117. The second light detecting section 302 detects the second reflected light, and based on the detected second reflected light, generates a second light detection signal 118.

The light detecting section 7 further comprises a third light detecting section 305 and a fourth light detecting section 306. The third light detecting section 305 detects a reflected light, and based on the detected reflected light, generates a first focus detection signal 303. The fourth light detecting section 306 detects a reflected light, and based on the detected reflected light, generates a second focus detection signal 304 (see FIG. 3C).

The first light detection signal 117, the second light detection signal 118, the first focus detection signal 303 and the second focus detection signal 304 are input to the servo processing block 3 and the data detecting block 8 (see FIG. 1).

Note that the light detecting section 7 detects light reflected from the groove 202 as well as light reflected from an adjacent land and the prepit 204 formed on the adjacent land. The light detecting section 7 does not need to detect the first reflected light and the second reflected light individually. The light detecting section 7 may only need to detect and obtain an asymmetric intensity distribution of light reflected from the optical disc 201 (asymmetry about the center line of a track where wobble is ignored), and based on the asymmetric intensity distribution of the reflected light, obtain a signal indicating the asymmetry of the shape of the track 206.

An optical head having a function of detecting light reflected from the optical disc 201 is herein referred to as an optical pickup 1 for the sake of convenience. The optical pickup 1 detects light reflected from one of the two side edge portions of the groove 202 and light reflected from the other side edge portion individually. In Embodiment 1, the side edge portion of the groove 202 refers to an area in a vicinity of the side end or edge of the groove 202 (a border between the groove 202 and the land 203 adjacent to the groove 202), and may thus include the adjacent land 203.

Referring back to FIG. 1, the configuration of the optical disc apparatus 100 will be described below.

The servo processing block 3 generates a focusing control signal a based on the first focus detection signal 303 and the second focus detection signal 304. The servo processing block 3 also generates a tracking control signal b based on the first light detection signal 117 and the second light detection signal 118.

The focusing control signal a and the tracking control signal bare input to the optical pickup 1. The servo processing block 3 controls the optical pickup 1 based on the focusing control signal a and the tracking control signal b in a manner that causes the optical pickup 1 to perform focusing and tracking accurately on the optical disc 201 using a laser beam. Note that focusing control and tracking control are achieved by known methods.

The data detecting block 8 detects data recorded on the optical disc 201 based on the first light detection signal 117, the second light detection signal 118, the first focus detection signal 303 and the second focus detection signal 304.

The first light detection signal 117 and the second light detection signal 118 are also input to the prepit signal detecting block 9 and the wobble detecting block 10.

The prepit signal detecting block 9 detects the prepit 204 based on the first light detection signal 117 and the second light detection signal 118.

The wobble detecting block 10 detects the wobble of the groove 202 based on the first light detection signal 117 and the second light detection signal 118.

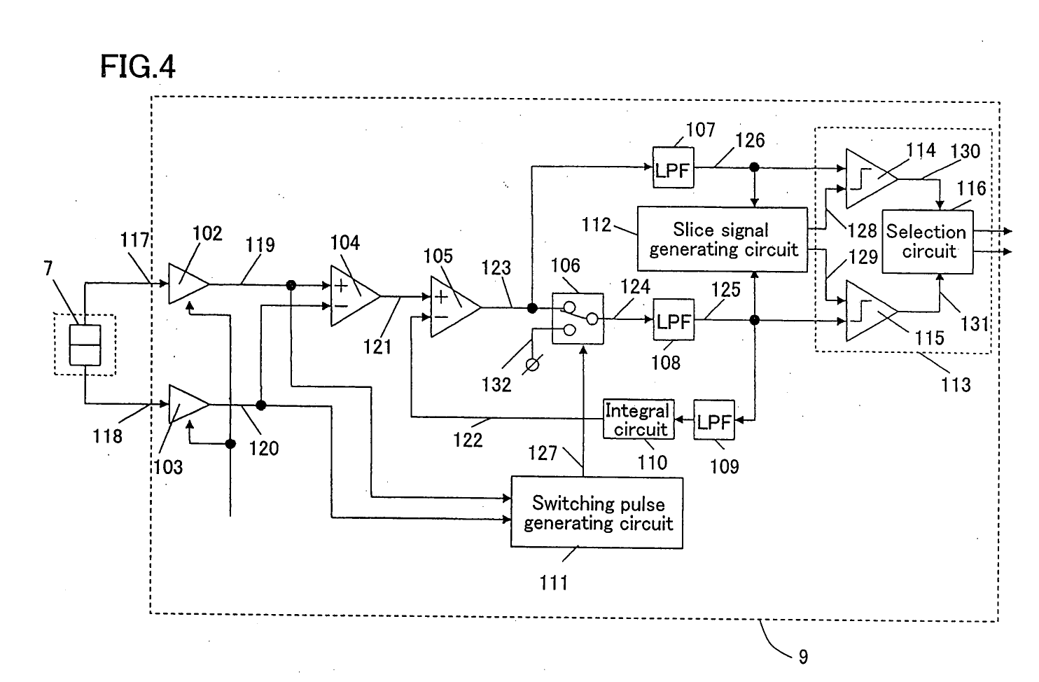

FIG. 4 shows an exemplary configuration of the prepit signal detecting block 9.

The prepit signal detecting block 9 comprises a first attenuator 102, a second attenuator 103 and a first subtraction circuit 104.

The first attenuator 102 adjusts an amplitude of the first light detection signal 117 to generate a first adjustment signal 119. The second attenuator 103 adjusts an amplitude of the second light detection signal 118 to generate a second adjustment signal 120.

The first attenuator 102 and the second attenuator 103 arbitrarily adjust a ratio of the amplitude of the first adjustment signal 119 to the amplitude of the second adjustment signal 120. For example, the first attenuator 102 and the second attenuator 103 adjust at least one of the amplitude of the first light detection signal 117 and the amplitude of the second light detection signal 118 so that the ratio of the amplitude of the first adjustment signal 119 to the amplitude of the second adjustment signal 120 is 1:1. Meticulous adjustment is not particularly required, i.e., any fixed ratio may be established.

The first subtraction circuit 104 generates a first difference signal 121 indicating a difference between the first adjustment signal 119 and the second adjustment signal 120.

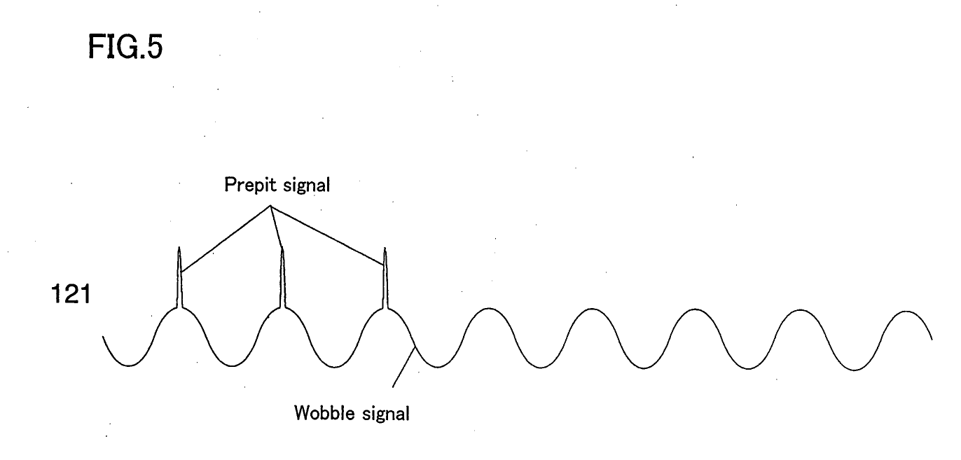

FIG. 5 shows the first difference signal 121 generated based on light reflected from an unrecorded track. The first difference signal 121 is, for example, a wobble signal. The wobble signal includes a prepit signal.

Referring back to FIG. 4, a configuration of the prepit signal detecting block 9 will be described below.

The prepit signal detecting block 9 further comprises a second subtraction circuit 105, a first LPF 107, a switching circuit 106, and a second LPF 108.

The second subtraction circuit 105 generates a second difference signal 123 indicating a difference between the first difference signal 121 and a feedback signal 122. Note that details of the second subtraction circuit 105 and the feedback signal 122 will be described elsewhere herein.

The second difference signal 123 is input to the switching circuit 106. The switching circuit 106 switches between an output of the second difference signal 123 and an output of a first reference signal 132 indicating a predetermined reference value. The switching circuit 106 replaces a portion of the second difference signal 123, which contains a signal component impeding the detection of a prepit signal (the signal component is hereinafter referred to as an “information recording signal component”), with the first reference signal to remove the information recording signal component from the second difference signal 123, resulting in a third difference signal 124. The first reference signal 132 indicates, for example, an average value of the third difference signal 124. Note that the information recording signal component occurs due to, for example, modulation of light emitted onto the track 206, or a difference between the reflectance of light reflected from an area, in which a recording mark is formed, and the reflectance of light reflected from an area, in which no recording mark is formed.

The third difference signal 124 is input to the second LPF 108. The second LPF 108 removes noise from the third difference signal 124 to generate a fourth difference signal 125. The second LPF 108 has an arbitrary cut-off frequency. The second LPF 108 may change the cut-off frequency, depending on reproduction speed. The cut-off frequency is, for example, about 4 MHz to about 10 MHz at 1× speed.

The second difference signal 123 is also input to the first LPF 107. The first LPF 107 generates a fifth difference signal 126 based on the second difference signal 123 in order to detect a prepit signal contained in the second difference signal 123. The first LPF 107 has the same function as that of the second LPF 108.

Hereinafter, a detail of the second subtraction circuit 105 will be described. Note that the prepit signal detecting block 9 further comprises a third LPF 109 and an integral circuit 110.

The fourth difference signal 125 is input to the third LPF 109. The third LPF 109 outputs a signal indicating an average value of the fourth difference signal 125. The signal indicating the average value is input to the integral circuit 110. The integral circuit 110 generates the feedback signal 122 which indicates information about variations in an average potential of the signal indicating the average value.

The second subtraction circuit 105 obtains a difference between the first difference signal 121 and the feedback signal 122 and causes the first difference signal 121 and the third difference signal 124 to have a predetermined potential. Note that the predetermined potential has an arbitrary level, which is, for example, an average value of the third difference signal 124.

The prepit signal detecting block 9 further comprises a switching pulse generating circuit 111 for generating a switching pulse 127, which is in synchronization with the timing of occurrence of the information recording signal component, and a slice signal generating circuit 112 for generating a first slice signal 128 and a second slice signal 129.

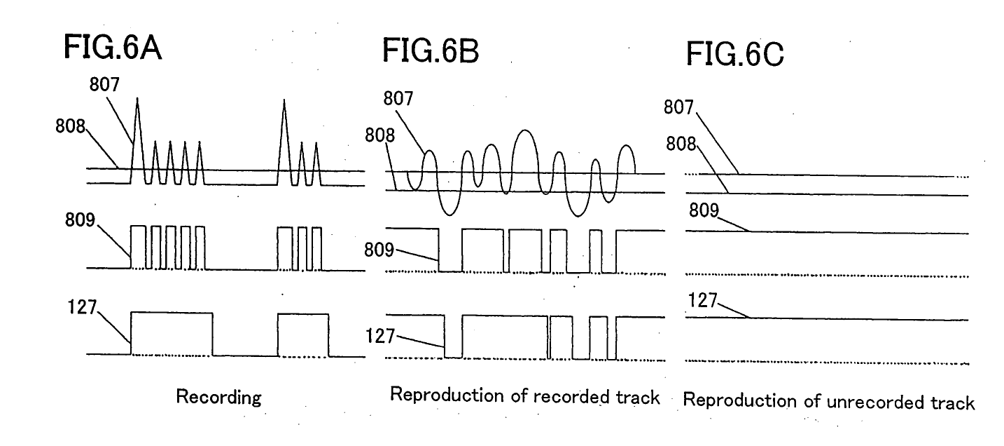

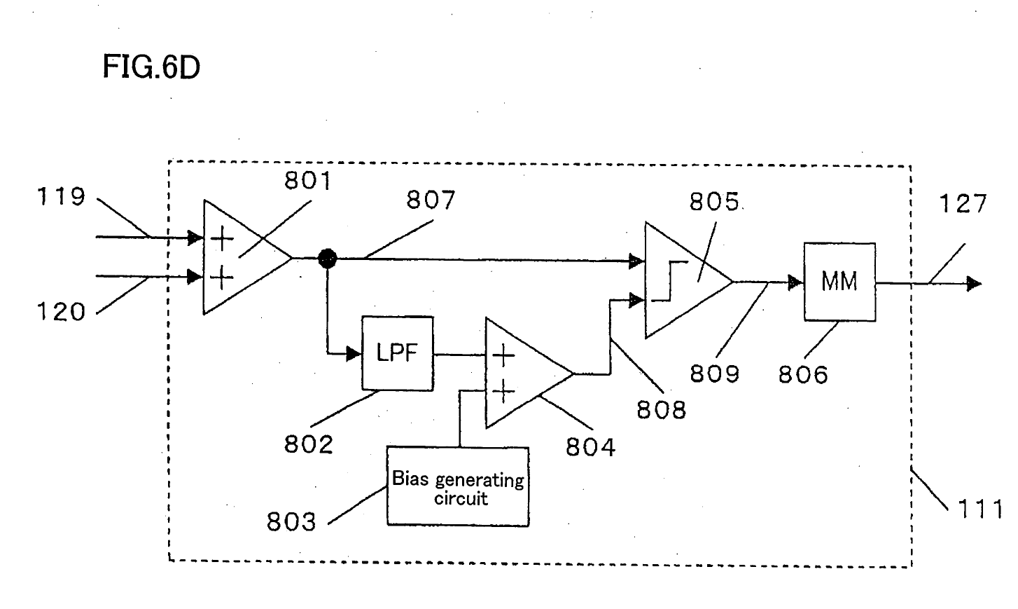

FIGS. 6A to 6D are diagrams for explaining a detail of an example of the switching pulse generating circuit 111.

FIG. 6A shows a waveform of a signal generated by a plurality of components included in the switching pulse generating circuit 111 when data is recorded onto the optical disc 201. FIG. 6B shows a waveform of a signal generated by a plurality of components included in the switching pulse generating circuit 111 when data is reproduced from the optical disc 201 (reproduction of a recorded track). FIG. 6C shows a waveform of a signal generated by a plurality of components included in the switching pulse generating circuit 111 when light is detected which is reflected from the track 206 in which no data is recorded (reproduction of an unrecorded track). FIG. 6D shows an exemplary configuration of the switching pulse generating circuit 111.

Hereinafter, a detail of an example of the switching pulse generating circuit 111 will be described with reference to FIGS. 6A to 6D.

The switching pulse generating circuit 111 comprises a first addition circuit 801, a fourth LPF 802, a bias generating circuit 803, a second addition circuit 804, a first comparison circuit 805, and a mono-multi circuit (MM) 806 (FIG. 6D).

The first addition circuit 801 generates a sum signal 807 indicating a sum of the first adjustment signal 119 and the second adjustment signal 120. The sum signal 807 is input to the fourth LPF 802. The fourth LPF 802 generates an average value signal based on the sum signal 807. The bias generating circuit 803 generates an offset signal. The bias generating circuit 803 can switch the offset signal between when data is reproduced and when data is recorded. For example, the bias generating circuit 803 causes the offset signal to have a ±0 potential when data is recorded and a −(minus) potential (one fourth of the wobble amplitude) when data is reproduced.

The second addition circuit 804 generates a comparison signal 808 indicating a sum (predetermined reference value) of the average value signal and an offset signal.

The first comparison circuit 805 compares the sum signal 807 with the comparison signal 808. When the sum signal 807 is greater than the comparison signal 808, the first comparison circuit 805 outputs a signal having a “HIGH” level. When the sum signal 807 is not greater than the comparison signal 808, the first comparison circuit 805 outputs a signal having a “LOW” level. In this manner, the first comparison circuit 805 generates a binary pulse 809.

The binary pulse 809 is input to the mono-multi circuit (MM) 806. The mono-multi circuit (MM) 806 generates the switching pulse 127 by increasing a pulse width of the binary pulse 809 (mono-multi mode). An operation of the mono-multi circuit 806 can be arbitrarily set. For example, the mono-multi circuit 806 can be set so that the pulse width is extended backward by 7 ns, 15 ns or 23 ns. Waveforms during recording and reproduction are shown in FIGS. 6A to 6C. Particularly, when an unrecorded track is reproduced (FIG. 6C), the switching pulse 127 is consistently “HIGH”.

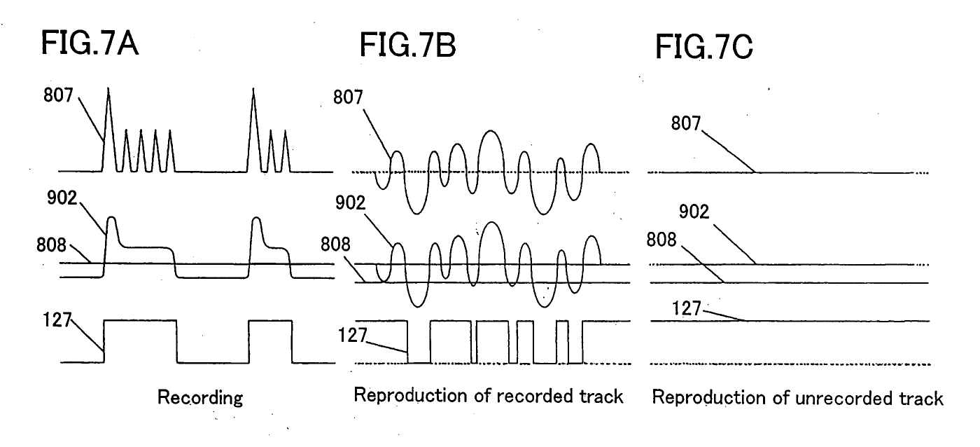

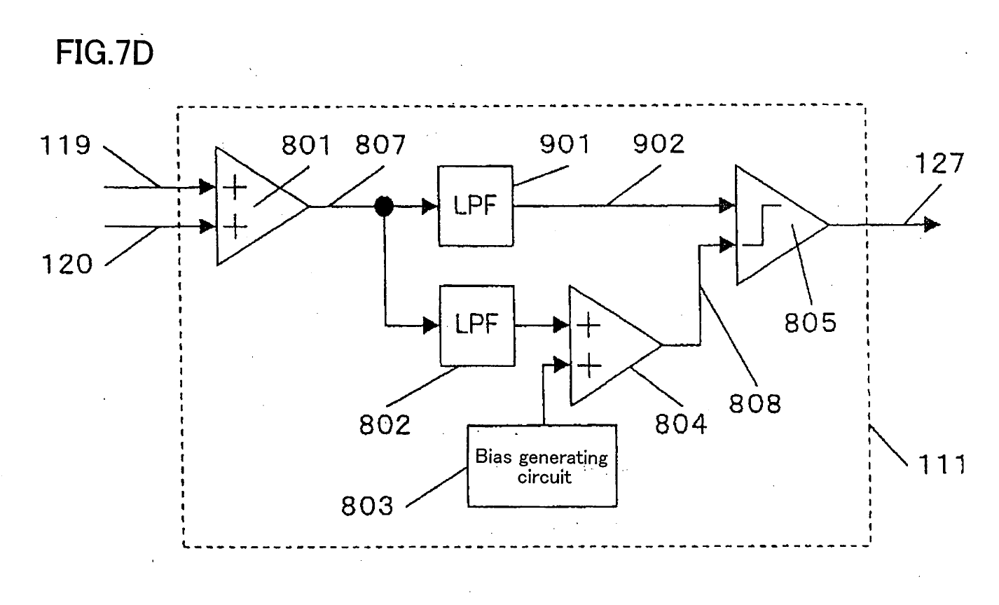

FIGS. 7A to 7D are diagrams for explaining a detail of another example of the switching pulse generating circuit 111.

FIG. 7A shows a waveform of a signal generated by a plurality of components included in the switching pulse generating circuit 111 when data is recorded onto the optical disc 201. FIG. 7B shows a waveform of a signal generated by a plurality of components included in the switching pulse generating circuit 111 when data is reproduced from the optical disc 201 (reproduction of a recorded track). FIG. 7C shows a waveform of a signal generated by a plurality of components included in the switching pulse generating circuit 111 when light reflected from the track 206, in which no data is recorded, is detected (reproduction of an unrecorded track). FIG. 7D shows a configuration of the switching pulse generating circuit 111.

Hereinafter, a detail of the above-described switching pulse generating circuit 111 will be described with reference to FIGS. 7A to 7D.

The switching pulse generating circuit 111 comprises a first addition circuit 801, a fourth LPF 802, a fifth LPF 901, a bias generating circuit 803, a second addition circuit 804 and a first comparison circuit 805 (FIG. 7D). In FIGS. 7A to 7D, the same component as those shown in the switching pulse generating circuit 111 of FIG. 6 are referenced with the same reference numerals and will not be explained.

Sum signal 807 is input to the fifth LPF 901. The fifth LPF 901 smoothes an information signal component of the sum signal 807 to generate a smoothed sum signal (sum signal 902). Note that a cut-off frequency of the fifth LPF 901 can be changed depending on reproduction speed as long as the information signal component can be smoothed. The cut-off frequency is, for example, about 4 MHz to about 14 MHz at 1× speed.

The first comparison circuit 805 compares the sum signal 902 with a comparison signal 808. When the sum signal 902 is greater than the comparison signal 808, the first comparison circuit 805 outputs a signal having a “HIGH” level. When the sum signal 902 is not greater than the comparison signal 808, the first comparison circuit 805 outputs a signal having a “LOW” level. In this manner, the first comparison circuit 805 generates the switching pulse 127. Particularly when an unrecorded track is reproduced (FIG. 7C), the switching pulse 127 is consistently “HIGH”.

As described above, the switching pulse 127 is generated based on, for example, the sum signal of the first adjustment signal 119 and the second adjustment signal 120. Alternatively, the switching pulse 127 may be generated based on a pulse signal which controls laser power.

As described with reference to FIGS. 6 and 7, when an unrecorded track is reproduced, the switching pulse 127 is “HIGH”. Therefore, the output of the switching pulse 106 is consistently at an arbitrary level 132. However, a recorded area detecting circuit 140 and a switching circuit 141 may be added to the switching pulse generating circuit 111 so that an output of the recorded area detecting circuit 140 can be input to the switching circuit 106 when an unrecorded track is reproduced, while an output of the switching pulse 127 can be input to the switching circuit 106 when a recorded track is reproduced.

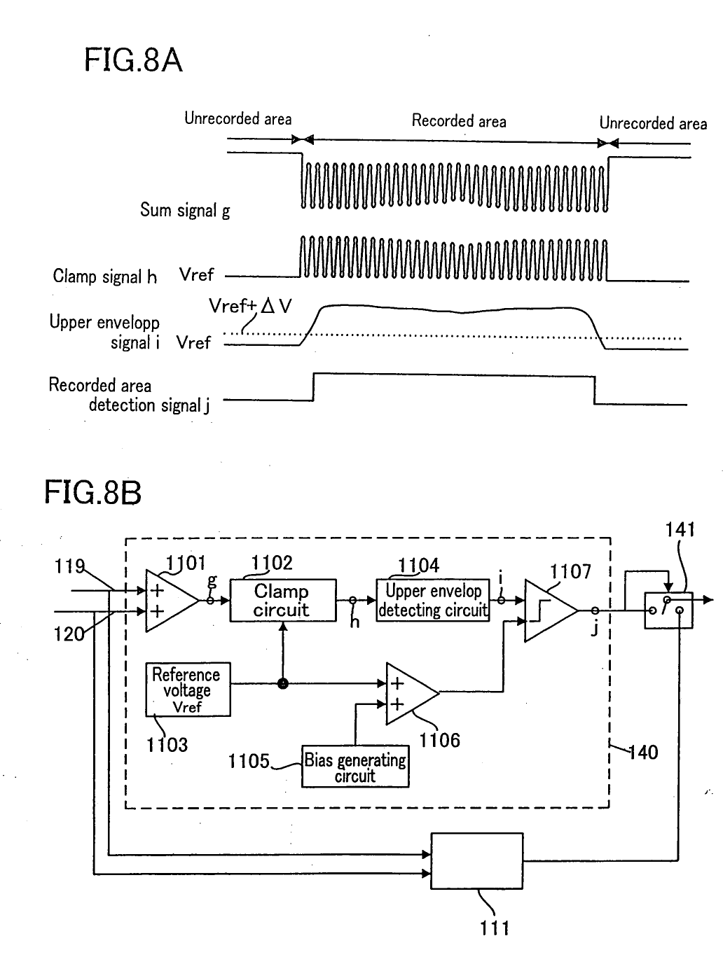

FIGS. 8A and 8B are diagrams for explaining a detail of the recorded area detecting circuit 140 and the switching circuit 141.

FIG. 8A shows a waveform of a signal generated by a plurality of components included in the recorded area detecting circuit 140. FIG. 8B shows configurations of the recorded area detecting circuit 140 and the switching circuit 141.

Hereinafter, the recorded area detecting circuit 140 and the switching circuit 141 will be described in detail with reference to FIGS. 8A and 8B.

The recorded area detecting circuit 140 comprises a third addition circuit 1101, a clamp circuit 1102, a reference voltage generating circuit 1103, an upper envelope detecting circuit 1104, a bias generating circuit 1105, a fourth addition circuit 1106 and a second comparison circuit 1107 (FIG. 8B).

The recorded area detecting circuit 140 receives a first adjustment signal 119 and a second adjustment signal 120.

The third addition circuit 1101 generates a sum signal g indicating a sum of the first adjustment signal 119 and the second adjustment signal 120. The sum signal g is input to the clamp circuit 1102. The reference voltage generating circuit 1103 generates a reference signal having a reference voltage Vref and outputs the reference signal to the clamp circuit 1102. The clamp circuit 1102 reverses the polarity of the sum signal g and clamps the sum signal having the reversed polarity at the reference voltage Vref, thereby generating a clamp signal h. The clamp signal h is input to the upper envelope detecting circuit 1104. The upper envelope detecting circuit 1104 detects an upper envelope signal i based on the clamp signal h. The upper envelope signal i is input to the second comparison circuit 1107.

The bias generating circuit 1105 generates a bias signal having a voltage ΔV. The fourth addition circuit 1106 generates a sum signal indicating a sum of the reference signal and the bias signal. The sum signal is input to the second comparison circuit 1107.

The second comparison circuit 1107 compares the sum signal with the upper envelope signal i. When the sum signal is greater than the upper envelope signal 1, the second comparison circuit 1107 outputs a signal having a “HIGH” level. When the sum signal is not greater than the upper envelope signal 1, the second comparison circuit 1107 outputs a signal having a “LOW” level. In this manner, the second comparison circuit 1107 generates a recorded area detection signal j.

When the recorded area detection signal j is “HIGH”, the recorded area detection signal j indicates that the optical disc apparatus 100 is accessing an area of the optical disc 201 (during reproduction of a recorded track), in which data is recorded. When the recorded area detection signal j is “LOW”, the recorded area detection signal j indicates that the optical disc apparatus 100 is accessing an area of the optical disc 201 (during reproduction of an unrecorded track), in which no data is recorded.

When the optical disc apparatus 100 is accessing an area of the optical disc 201, in which no data is recorded, the “LOW” recorded area detection signal j is input to the switching circuit 141. In this case, the switching circuit 141 is switched so that an output (“LOW” signal) of the recorded area detecting circuit 140 is output. The “LOW” recorded area detection signal J is input to the switching circuit 106. The switching circuit 106 is switched based on the recorded area detection signal j so that only the second difference signal 123 is output (see FIG. 4). Note that when the optical disc apparatus 100 is accessing an area of the optical disc 201, in which no data is recorded, the switching circuit 106 does not need to be switched so as to remove an information recording signal component from the second difference signal 123, since the second difference signal 123 does not contain the information recording signal component.

When the optical disc apparatus 100 is accessing an area of the optical disc 201, in which data is recorded, the “HIGH” recorded area detection signal j is input to the switching circuit 141. In this case, the switching circuit 141 is switched so that an output of the switching pulse generating circuit 111 is output. The switching pulse 127 is input to the switching circuit 106. The switching circuit 106 switches outputs based on the switching pulse 127 (FIG. 4).

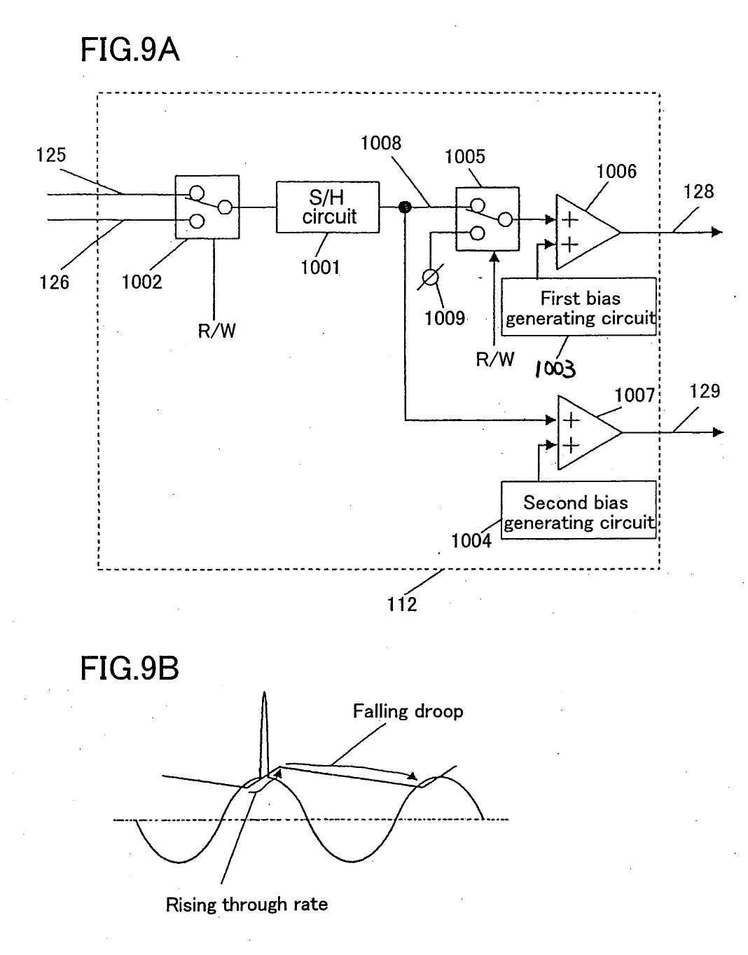

FIGS. 9A and 9B are diagrams for explaining a detail of the slice signal generating circuit 112. FIG. 9A shows a configuration of the slice signal generating circuit 112. FIG. 9B shows a rising through rate and a falling droop.

Hereinafter, a detail of the slice signal generating circuit 112 will be described with reference to FIGS. 9A and 9B.

The slice signal generating circuit 112 comprises a sample hold circuit 1001, a first switch 1002, a first bias generating circuit 1003, a second bias generating circuit 1004, a second switch 1005, a fifth addition circuit 1006 and a sixth addition circuit 1007 (FIG. 9A).

When data is reproduced from the optical disc 201, the first switch 1002 is switched so that the fifth difference signal 126 is input to the sample hold circuit 1001. When data is recorded onto the optical disc 201, the first switch 1002 is switched so that the fourth difference signal 125 is input to the sample hold circuit 1001.

The sample hold circuit 1001 rises at an arbitrary through rate in response to a signal output from the first switch 1002 and falls with an arbitrary droop, and outputs a sample hold signal 1008 (see FIG. 9B). For example, the rising through rate does not respond excessively to a prepit signal and the falling droop responds more slowly than the rising through rate. The response rate can be changed depending on a reproduction rate. For example, when the reproduction rate is 1× speed, the rising through rate for 1 μs is 5% to 20% of the wobble amplitude and the falling droop is one tenth of the rising through rate.

When data is reproduced from the optical disc 201, the second switch 1005 is switched so that the sample hold signal 1008 is input to the fifth addition circuit 1006. When data is recorded onto the optical disc 201, the second switch 1005 is switched so that a signal 1009 having an arbitrary potential is input to the fifth addition circuit 1006. For example, the signal 1009 has a reference potential which is determined depending on a circuit.

The first bias generating circuit 1003 generates a first offset signal. The first offset signal is input to the fifth addition circuit 1006.

When data is recorded from the optical disc 201, the fifth addition circuit 1006 generates a first slice signal 128 by adding the sample hold signal 1008 with the first offset signal. When data is recorded onto the optical disc 201, the fifth addition circuit 1006 generates the first slice signal 128 by adding the signal 1009 with the first offset signal.

The second bias generating circuit 1004 generates a second offset signal. The second offset signal is input to the sixth addition circuit 1007.

When data is reproduced from the optical disc 201 and when data is recorded onto the optical disc 201, the sixth addition circuit 1007 generates a second slice signal 129 by adding the sample hold signal 1008 with the second offset signal.

Note that the first offset signal and the second offset signal may be changed to arbitrary values depending on when data is reproduced from the optical disc 201 and when data is recorded onto the optical disc 201.

Referring back to FIG. 4, a configuration of the prepit signal detecting block 9 will be described below.

The prepit signal detecting block 9 further comprises a prepit detecting circuit 113.

The prepit detecting circuit 113 comprises a third comparison circuit 114, a fourth comparison circuit 115 and a selection circuit 116.

The third comparison circuit 114 compares the fifth difference signal 126 with the first slice signal 128. When the fifth difference signal 126 is greater than the first slice signal 128, the third comparison circuit 114 outputs a signal having a “HIGH” level. When the fifth difference signal 126 is not greater than the first slice signal 128, the third comparison circuit 114 outputs a signal having a “LOW” level. In this manner, the third comparison circuit 114 generates a first prepit detection signal 130.

The fourth comparison circuit 115 compares the fourth difference signal 125 with the second slice signal 129. When the fourth difference signal 125 is greater than the second slice signal 129, the fourth comparison circuit 115 outputs a signal having a “HIGH” level. When the fourth difference signal 125 is not greater than the second slice signal 129, the fourth comparison circuit 115 outputs a signal having a “LOW” level. In this manner, the fourth comparison circuit 115 generates a second prepit detection signal 131.

The selection circuit 116 outputs at least one of the first prepit detection signal 130 and the second prepit detection signal 131. For example, a signal obtained by passing the first prepit detection signal 130 and the second prepit detection signal 131 through an OR circuit, and the first prepit detection signal 130 may be output. Alternatively, both the first prepit detection signal 130 and the second prepit detection signal 131 may be output.

Thus, the prepit detecting circuit 113 references the sample hold signal 1008 generated based on the fourth difference signal 125 and the sample hold signal 1008 generated based on the fifth difference signal 126.

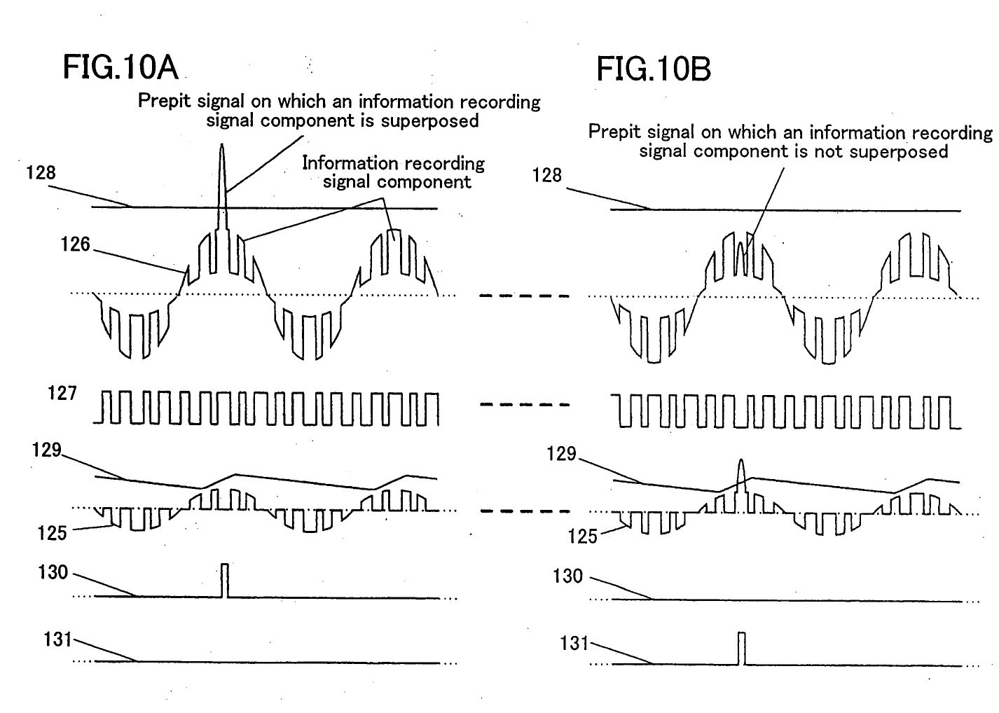

FIGS. 10A and 10B show waveforms of signals generated by a plurality of components included in the prepit detecting block 9 when data is recorded onto the optical disc 201. Laser power during data recording is several to several tens of times that during data reproduction, so that the signal amplitude is increased.

Hereinafter, a waveform of a signal generated by a plurality of components included in the prepit detecting block 9 when data is recorded onto the optical disc 201, will be described with reference to FIGS. 4, 10A and 10B.

FIG. 10A shows a waveform of a signal, in which an information recording signal component is superposed on a prepit signal.

When an information recording signal component is superposed on a prepit signal, the amplitude of the prepit signal is larger than the amplitude of a wobble signal on which an information recording signal component is superposed. Therefore, the third comparison circuit 114 compares the fifth difference signal 126 with the first slice signal 128 to generate the first prepit detection signal 130, and based on the first prepit detection signal 130, detects a prepit. On the other hand, the fourth difference signal 125 does not contain a prepit signal. Therefore, a prepit cannot be detected based on the second prepit detection signal 131. As a result, the prepit signal detecting block 9 can detect a prepit based on the first prepit detection signal 130.

FIG. 10B shows a waveform of a signal when no information recording signal component is superposed on a prepit signal.

When no information recording signal component is superposed on a prepit signal, the amplitude of a wobble signal on which an information recording signal component is superposed is larger than the amplitude of the prepit signal. Therefore, the third comparison circuit 114 cannot detect the prepit signal based on the fifth difference signal 126. To avoid this, an interval on which the information recording signal component is superposed is switched to an arbitrary level 132 by the switching circuit 106 to remove the information recording signal component, thereby producing the third difference signal 124. The third difference signal 124 is input to the second LPF 108 to generate the fourth difference signal 125. The fourth difference signal 125 contains no information recording signal component. Therefore, the fourth comparison circuit 115 compares the fourth difference signal 125 with the second slice signal 129 to generate the second prepit detection signal 131. The prepit signal detecting block 9 can detect a prepit based on the second prepit detection signal 131.

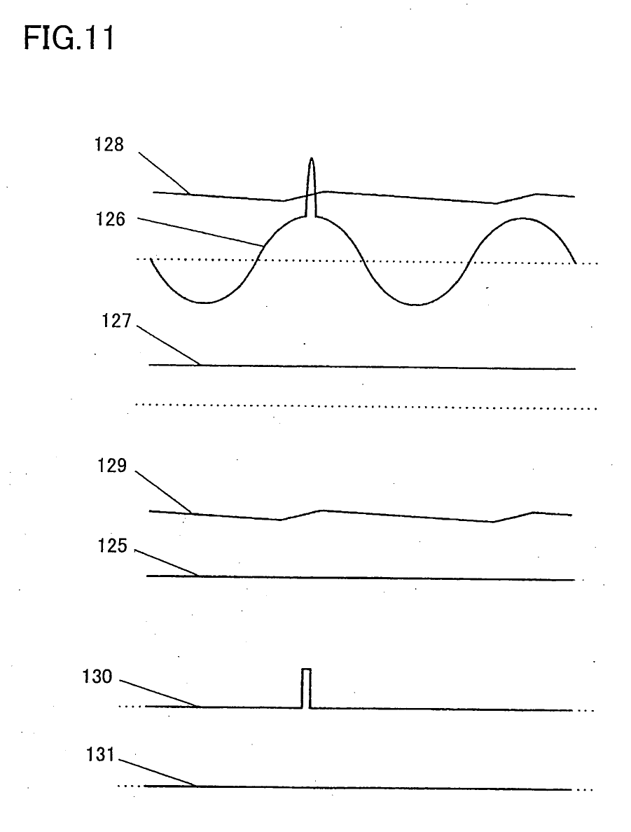

FIG. 11 shows a waveform of a signal generated by a plurality of components included in the prepit detecting block 9 when light reflected from the track 206, in which no data is recorded (reproduction of an unrecorded track), is detected.

Hereinafter, a waveform of a signal generated by a plurality of components included in the prepit detecting block 9 when an unrecorded track is reproduced, will be described with reference to FIGS. 4 and 11.

No information recording mark is formed in an unrecorded track. Therefore, the third comparison circuit 114 compares the fifth difference signal 126 with the first slice signal 128 to generate the first prepit detection signal 130, thereby detecting a prepit based on the first prepit detection signal 130. When an unrecorded track is reproduced, the switching pulse 127 is consistently “HIGH” and the third difference signal 124 is consistently at the arbitrary level 132. Therefore, although no prepit can be detected based on the second prepit detection signal 131, a prepit can be detected based on the first prepit detection signal 130. As a result, the prepit signal detecting block 9 can detect a prepit based on the first prepit detection signal 130.

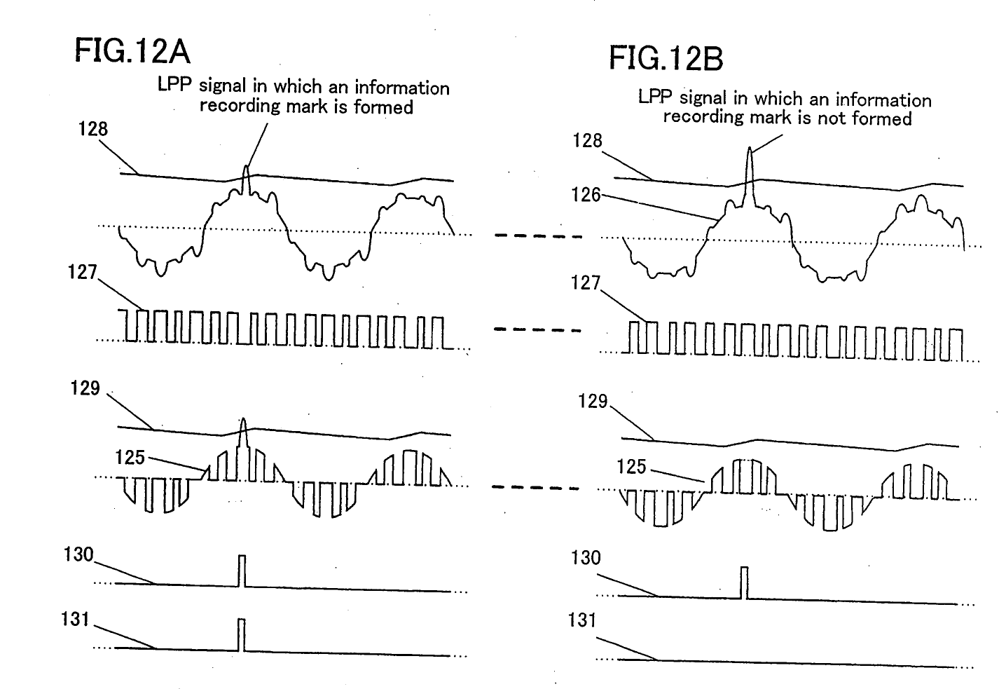

FIGS. 12A and 12B show waveforms of signals generated by a plurality of components included in the prepit detecting block 9 when data is reproduced from the optical disc 201 (reproduction of a recorded track). When a recorded track is reproduced, the amplitude of a prepit signal is small since the reflectance of a portion, in which an information recording mark is formed, is smaller than the reflectance of a portion, in which no information recording mark is formed.

Hereinafter, a waveform of a signal generated by a plurality of components included in the prepit detecting block 9 when a recorded track is reproduced, will be described with reference to FIGS. 4, 12A and 12B.

FIG. 12A shows a waveform of a signal when an information recording mark is formed in a prepit signal interval.

When an information recording mark is formed in a prepit signal interval, the amplitude of a prepit signal is small while the amplitude of a wobble signal formed based on light reflected from a groove, in which no information recording mark is recorded, is large. Therefore, it is difficult to detect a prepit. However, the third comparison circuit 114 compares the fifth difference signal 126 with the first slice signal 128 to generate the first prepit detection signal 130, thereby detecting a prepit based on the first prepit detection signal 130. In addition, by switching an interval, in which no information recording mark is formed, to an arbitrary level 132 using the switching circuit 106, an information recording signal component having a large amplitude is removed from a wobble signal. Therefore, the fourth comparison circuit 115 compares the fourth difference signal 125 with the second slice signal 129 to generate the second prepit detection signal 131, thereby detecting a prepit based on the second prepit detection signal 131.

The prepit signal detecting block 9 detects a prepit based on at least one of the first prepit detection signal 130 and the second prepit detection signal 131.

FIG. 12B shows a waveform of a signal when no information recording mark is formed in a prepit signal interval (no information recording component is superposed on a prepit signal).

When no information recording mark is formed in a prepit signal interval, the amplitude of a prepit signal is large. Therefore, the third comparison circuit 114 compares the fifth difference signal 126 with the first slice signal 128 to generate the first prepit detection signal 130, thereby detecting a prepit based on the first prepit detection signal 130. On the other hand, no prepit signal is contained in the fourth difference signal 125. Therefore, no prepit can be detected based on the second prepit detection signal 131. As a result, the prepit signal detecting block 9 can detect a prepit based on the first prepit detection signal 130.

### Embodiment 2

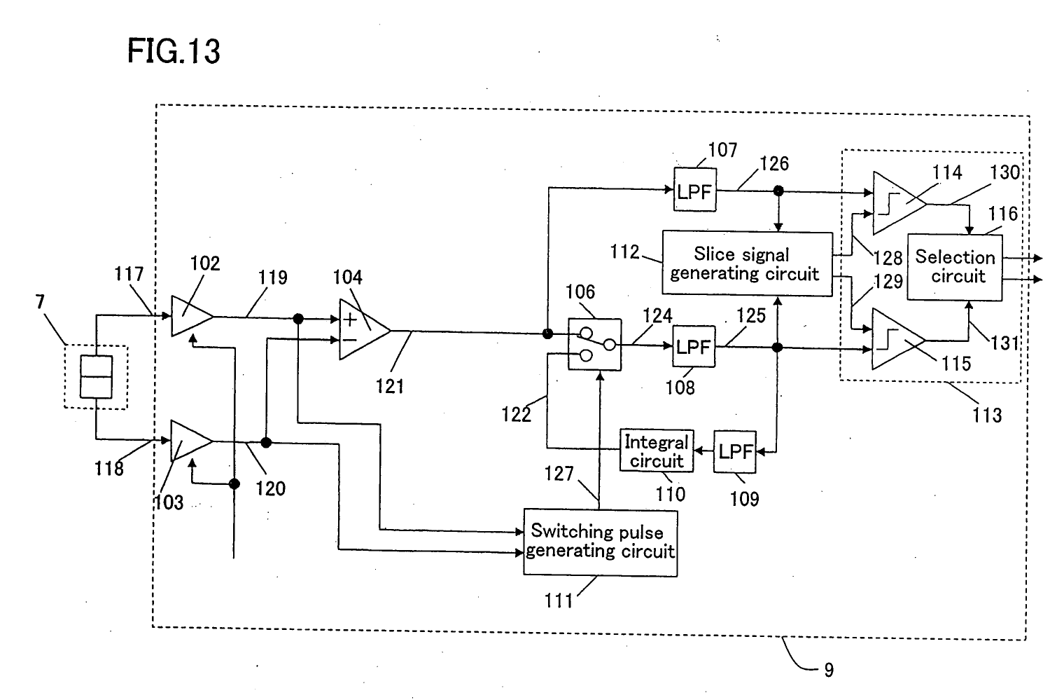

FIG. 13 shows another exemplary configuration of the prepit signal detecting block 9. In FIG. 13, the same components as those of the prepit signal detecting block 9 of FIG. 4 are referenced with the same reference numerals and will not be explained.

A switching circuit 106 switches a signal in an arbitrary interval of a first difference signal 121 to a feedback signal 122, thereby removing an information recording signal component to generate a third difference signal 124. The value of the feedback signal 122 is an average value of the third difference signal 124.

In the above-described Embodiment 1, as described with reference to FIG. 4, the potential of the first difference signal 121 is caused to be at an arbitrary level based on the feedback signal 122, and a signal level after replacement by switching of the switching circuit 106 is an arbitrary fixed level. In Embodiment 2, a signal level after replacement by switching of the switching circuit 106 is a potential level of the feedback signal 122. Therefore, the potential level of a signal generated by the prepit signal detecting block 9 having the configuration described in Embodiment 2 is shifted by the potential level of the feedback signal 122 toward a plus or minus side from the potential level of a signal generated by the prepit signal detecting block 9 having the configuration described in Embodiment 1. These signals have the same shape, except for the shift amount. Therefore, a prepit can be stably detected.

Embodiments 1 and 2 of the present invention have been described.

For example, in the embodiment of FIGS. 1 and 2, the light irradiation section 11 corresponds to a “light irradiation section for irradiating at least one track with light”. The light detecting section 7, the first attenuator 102, the second attenuator 103 and the first subtraction circuit 104 correspond to a “first signal generating section for detecting light reflected from at least one track, and based on the reflected light, generating a first signal including a prepit signal indicating at least one prepit”, the switching circuit 106 and the switching pulse generating circuit 111 correspond to a “second signal generating section for removing a signal component impeding detection of the prepit signal from the first signal to generate a second signal”, and the prepit detecting circuit 113 corresponds to a “prepit detecting section for detecting at least one prepit based on at least one of the first signal and the second signal”. However, the optical disc apparatus of the present invention is not limited to the embodiment of FIG. 1. As long as the functions of the above-described sections can be achieved, an optical disc apparatus having any configuration falls within the scope of the present invention.

For example, the prepit signal detecting block 9 described with reference to FIGS. 1 and 4 may further comprise a signal cutting section. The signal cutting section cuts a signal input to the integral circuit 110 so that the value of an output signal (feedback signal 122) from the integral circuit 110 is constant. The signal cutting section is provided downstream of the integral circuit 110 so that the integral circuit 110 can output a signal having a constant value. For example, the signal cutting section may be provided between the third LPF 109 and the integral circuit 110. The signal cutting section may be provided immediately before the third LPF 109.

Each section described in the embodiment of FIGS. 1 and 4 may be implemented with either, or both, hardware and software. In any of these cases, the optical disc apparatus 100 may perform an access process comprising “irradiating at least one track with light”, “detecting light reflected from the at least one track, and based on the detected reflected light, generating a first signal including a prepit signal indicating at least one prepit”, “removing a signal component impeding detection of the prepit signal from the first signal to generate a second signal” and “detecting at least one prepit based on at least one of the first signal the second signal”. The access process of the present invention may comprise any procedure as long as the above-described steps can be performed.

For example, the optical disc apparatus of the present invention may store an access process program for causing the optical disc apparatus to perform the functions thereof. The access process program causes the optical disc apparatus to perform the functions thereof.

The access process program may be stored into a storage section included in the optical disc apparatus before a computer is shipped. Alternatively, the access process program may be stored into such a storage section after a computer is shipped. For example, users may download the access process program from a particular website on the Internet with or without payment, and install the downloaded program into a computer. When the access process program is recorded on a computer readable recording medium, such as a flexible disc, a CD-ROM, a DVD-ROM or the like, the access process program may be installed into a computer via an input apparatus (e.g., a disc drive apparatus). The installed access process program is stored in a storage section.

Further, according to the optical disc apparatus of the present invention, a prepit may be detected by an analog circuit, or alternatively, a prepit may be detected after analog-to-digital conversion.

For example, the prepit signal detecting block 9 may be produced as a one-chip LSI (semiconductor integrated circuit) or a portion thereof. When the prepit signal detecting block 9 is produced as a one-chip LSI, the manufacturing process of the optical disc apparatus 100 can be made simpler.

According to the optical disc apparatus, the prepit detecting method, the program and the semiconductor integrated circuit of the present invention, a signal component impeding the detection of a prepit signal can be removed. Therefore, the present invention is useful for detection of a prepit on a DVD-R or the like. Moreover, the present invention can be applied to noise removal for detection of a wobble signal during reproduction of an optical disc, for example.

Although certain preferred embodiments have been described herein, it is not intended that such embodiments be construed as limitations on the scope of the invention except as set forth in the appended claims. Various other modifications and equivalents will be apparent to and can be readily made by those skilled in the art, after reading the description herein, without departing from the scope and spirit of this invention. All patents, published patent applications and publications cited herein are incorporated by reference as if set forth fully herein.

1. An optical disc apparatus for accessing an optical disc having at least one track, wherein at least one prepit is provided in the at least one track, the apparatus comprising:
a light irradiation section for irradiating the at least one track with light;
a first signal generating section for detecting light reflected from the at least one track, and based on the reflected light, generating a first signal including a prepit signal indicating the at least one prepit;
a second signal generating section for removing a signal component impeding detection of the prepit signal from the first signal to generate a second signal; and
a prepit detecting section for detecting the at least one prepit based on at least one of the first signal and the second signal.

2. An optical disc apparatus according to claim 1, wherein:
the at least one track comprises an outer circumferential area on an outer circumferential side of a center of the track and an inner circumferential area on an inner circumferential side of the center of the track;
the reflected light comprises afirst reflected light reflected from the outer circumferential area and a second reflected light reflected from the inner circumferential area; and
the first signal generating section comprises:
a first light detection signal generating section for detecting the first reflected light, and based on the detected first reflected light, generating a first light detection signal;
a second light detection signal generating section for detecting the second reflected light, and based on the detected second reflected light, generating a second light detection signal; and
a difference signal generating section for generating the first signal based on a difference between the first light detection signal and the second light detection signal.

3. An optical disc apparatus according to claim 2, wherein the difference signal generating section comprises:
an adjustment section for adjusting at least one of an amplitude of the first light detection signal and an amplitude of the second light detection signal so that a ratio of the amplitude of the first light detection signal and the amplitude of the second light detection signal is 1:1.

4. An optical disc apparatus according to claim 1, further comprising:
a feedback section for feedbacking a predetermined signal to the first signal to cause the second signal to have a predetermined potential.

5. An optical disc apparatus according to claim 4, wherein the feedback section feedbacks the predetermined signal to the first signal so that a value of the predetermined potential is an average value of the second signal.

6. An optical disc apparatus according to claim 4, further comprising a section for causing an output value of the feedback section to be constant.

7. An optical disc apparatus according to claim 4, wherein the second signal generating section comprises:
a synchronization signal generating section for generating a synchronization signal which is in synchronization with a timing of occurrence of the signal component; and
a switching section for switching, based on the synchronization signal, between an output of the first signal and an output of a first reference signal indicating a predetermined reference value.

8. An optical disc apparatus according to claim 7, wherein:
the at least one track comprises an outer circumferential area on an outer circumferential side of a center of the track and an inner circumferential area on an inner circumferential side of the center of the track;
the reflected light comprises a first reflected light reflected from the outer circumferential area and a second reflected light reflected from the inner circumferential area; and
the first signal generating section comprises:
a first light detection signal generating section for detecting the first reflected light, and based on the detected first reflected light, generating a first light detection signal; and
a second light detection signal generating section for detecting the second reflected light, and based on the detected second reflected light, generating a second light detection signal,
the synchronization signal generating section comprises:
a sum signal generating section for generating a sum signal indicating a sum of the first light detection signal and the second light detection signal;
a binary signal generating section for generating a binary signal based on the sum signal and a second reference signal indicating a predetermined reference value; and
a mono-multi section for changing the binary signal to amono-multi signal to generate the synchronization signal.

9. An optical disc apparatus according to claim 7, wherein:
the at least one track comprises an outer circumferential area on an outer circumferential side of a center of the track and an inner circumferential area on an inner circumferential side of the center of the track;
the reflected light comprises a first reflected light reflected from the outer circumferential area and a second reflected light reflected from the inner circumferential area; and
the first signal generating section comprises:
a first light detection signal generating section for detecting the first reflected light, and based on the detected first reflected light, generating a first light detection signal;
a second light detection signal generating section for detecting the second reflected light, and based on the detected second reflected light, generating a second light detection signal; and
the synchronization signal generating section comprises:
a sum signal generating section for generating a sum signal indicating a sum of the first light detection signal and the second light detection signal;
a filtering section for filtering the sum signal; and
a binary signal generating section for generating a binary signal based on the filtered sum signal and a third reference signal indicating a predetermined reference value.

10. An optical disc apparatus according to claim 7, wherein:
the first reference signal indicates an average value of the second signal.

11. An optical disc apparatus according to claim 7, wherein:
the synchronization signal generating section further comprises a determination section for determining whether or not the optical disc apparatus is accessing an area of the optical disc in which data is recorded; and
when the determination section determines that the optical disc apparatus is not accessing the area, the switching section maintains the output of the first signal.

12. An optical disc apparatus according to claim 1, wherein:
the signal component is generated by modulation of the light; and
the signal component is superposed on the first signal.

13. An optical disc apparatus according to claim 1, wherein:
the at least one track comprises at least one formation area, in which at least one recording mark is provided;
the signal component is generated due to a difference between a reflectance of light reflected from the at least one formation area and a reflectance of light reflected from an area other than the at least one formation area; and
the signal component is superposed on the first signal.

14. An optical disc apparatus according to claim 1, wherein:
the prepit detecting section detects the at least one prepit with reference to a sample hold signal generated based on the first signal.

15. An optical disc apparatus according to claim 1, wherein:
the prepit detecting section detects the at least one prepit with reference to a sample hold signal generated based on the second signal.

16. An optical disc apparatus according to claim 1, wherein:
the prepit detecting section detects the at least one prepit with reference to a sample hold signal generated based on an average value of the second signal.

17. An access method for accessing an optical disc having at least one track, wherein at least one prepit is provided in the at least one track, the method comprising:
irradiating the at least one track with light;
detecting light reflected from the at least one track, and based on the reflected light, generating a first signal including a prepit signal indicating the at least one prepit;
removing a signal component impeding detection of the prepit signal from the first signal to generate a second signal; and
detecting the at least one prepit based on at least one of the first signal and the second signal.

18. A program for causing a computer to execute an access process for accessing an optical disc having at least one track, wherein at least one prepit is provided in the at least one track, the access process comprising:
irradiating the at least one track with light;
detecting light reflected from the at least one track, and based on the reflected light, generating a first signal including a prepit signal indicating the at least one prepit;
removing a signal component impeding detection of the prepit signal from the first signal to generate a second signal; and
detecting the at least one prepit based on at least one of the first signal and the second signal.

19. A semiconductor integrated circuit for controlling access to an optical disc having at least one track, wherein at least one prepit is provided in the at least one track, the circuit comprising:
a first signal generating section for detecting light reflected from the at least one track, and based on the reflected light, generating a first signal including a prepit signal indicating the at least one prepit;
a second signal generating section for removing a signal component impeding detection of the prepit signal from the first signal to generate a second signal; and
a prepit detecting section for detecting the at least one prepit based on at least one of the first signal and the second signal.
